(19) United States
(12) Patent Application Publication
(10) Pub. No.: US 2025/0052431 A1
(43) Pub. Date: Feb. 13, 2025

(54) A HEATING SYSTEM THAT PRODUCES HEAT FROM A SOURCE OF ROTATIONAL MOTION

(71) Applicant: H20 Turbines Ltd., Essex (GB)

(72) Inventor: Clifford Mark Spilsbury, Essex (GB)

(73) Assignee: H2O Turbines Ltd., Essex (GB)

(21) Appl. No.: 18/709,337

(22) PCT Filed: Nov. 10, 2022
(86) PCT No.: PCT/GB2022/052853

§ 371 Date: May 10, 2024

(30) Foreign Application Priority Data
Nov. 12, 2021 (GB) 2116309.2

(51) Int. Cl. F24D 11/00; F24D 11/02

(52) U.S. Cl. CPC F24D 11/001; F24D 11/02; F24D 2200/123

(57) ABSTRACT

A heating system comprises a source of rotational motion, at least one pump, a primary heat storage system, and one or more loops of piping connected to the primary heat storage system. The source of rotational motion, which may be a wind turbine, is configured to drive the at least one pump. The at least one pump is configured to pump liquid to repeatedly circulate around the one or more loops of piping, resulting in frictional heating of the pumped liquid and transfer of heat to the primary heat storage system. The system may comprise a secondary heat storage system, the pump may have an efficiency of less than 20%, the wind turbine may have drag-style blades, and/or the system may comprise a flow valve to regulate a flow rate of the pumped liquid.

### FIELD OF THE INVENTION

The present invention relates to a heating system that produces heat from a source of rotational motion, for example a wind turbine.

### BACKGROUND OF THE INVENTION

Domestic residences and industrial installations typically require heating systems to provide heat for heating rooms, or for providing hot water supplies. There is a desire to provide the heat as economically as possible, whilst minimising carbon dioxide emissions.

The Applicant's patent publication WO 2018/096364 A1 discloses an apparatus for heating a liquid, in which a source of rotational motion such as a wind turbine is used to pump liquid through a circuit of piping including a friction pipe, causing the temperature of the liquid to rise. This provides efficient conversion of wind energy into heat, since there is no intermediate step of electricity generation.

However, one of the problems with such a system is that it only provides heating when the wind turbine is in motion, i.e. in windy weather conditions. There is a desire to provide a heating system which can deliver heat even at times when the wind does not blow.

### SUMMARY OF THE INVENTION

According to a first aspect of the invention, there is provided a heating system, comprising a source of rotational motion, at least one pump, primary and secondary heat storage systems, one or more loops of piping connected to the primary and secondary heat storage systems, and a heat pump connected between the primary and secondary heat storage systems. The source of rotational motion is configured to drive the at least one pump, and the at least one pump is configured to pump liquid to repeatedly circulate around the one or more loops of piping, resulting in frictional heating of the pumped liquid and transfer of heat to the primary and secondary heat storage systems. The primary heat storage system is configured to store a smaller amount of thermal energy at a higher temperature than the secondary heat storage system is configured to store, and the heat pump is configured to transfer thermal energy from the secondary heat storage system to the primary heat storage system.

The heating system therefore provides a primary heat storage system that may be drawn upon as a source of heat for purposes such as heating rooms or providing hot water supplies. The source of rotational motion pumps liquid, resulting in frictional heating of the pumped liquid, which heat can be stored in the primary heat storage system. The primary heat storage system may for example store heat at a primary storage temperature of 40° C. to 90° C., more preferably 60° C. to 70° C. At times when the source of rotational motion does not deliver sufficient rotational motion to heat the pumped liquid enough to maintain a minimum required temperature of the primary heat storage system, the heat pump may be used to supply thermal energy from the secondary heat storage system to the primary heat storage system to help maintain the primary storage temperature of the primary heat storage system.

The capacity of the primary heat storage system is preferably sufficient to supply several hours of heat demand in the absence of heat from the pumped liquid before the temperature of the primary heat storage system drops sufficiently to require the heat pump to be turned on. Therefore, short-term variations in the heat delivered by the pumped liquid as may occur during each day may be accommodated by the primary heat storage system without any need to turn on the heat pump. The capacity of the primary heat storage system may be sufficient to supply 24 hours of heat demand, meaning that the heat pump may only need to be turned on at night, when electricity rates are cheapest.

A conventionally configured heat pump may use compression to increase the temperature of fluid from ambient air temperature, typically yielding three to four times more thermal energy than the electrical energy required to run the compressor. However, a heat pump configured in accordance with the invention draws heat from the secondary heat storage system rather than from the ambient environment, requiring the compressor to do less work to raise the temperature of the fluid to the required temperature of the primary heat storage system. This raises the efficiency of the heat pump, typically yielding 8-10 times more thermal energy than the electrical energy required to run the compressor. The secondary heat storage system may for example store heat at a temperature of 20° C. to 45° C., more preferably 30° C. to 35° C. It will be appreciated that the term ‘fluid’ includes both gasses and liquids, and the fluid driven by the heat pump may transition between gaseous and liquid phases, as will be apparent to those skilled in the art.

The heat pump may be configured to repeatedly circulate fluids through the primary and secondary heat storage systems, and may comprise a compressor configured to raise a temperature of the fluid when flowing from the secondary heat storage system, thereby enabling storage of heat in the primary heat storage system. The fluids circulated through the primary and secondary heat storage systems may be the same fluids as one another, or they may be different fluids with a heat exchanger positioned between them at the heat pump.

At times when the source of rotational motion delivers more than enough rotational motion to heat the pumped liquid by more than enough to maintain the required temperature of the primary heat storage system, the pumped liquid may be routed to the secondary heat storage system to transfer the excess heat to the secondary heat storage system, for longer term storage. The lower temperature of the secondary heat storage system means that heat is more easily stored for long periods of time without dissipating into the surrounding environment, and the large thermal capacity of the secondary heat storage system means that a large volume of heat can be stored, potentially for months at a time. This allows the heat pump to efficiently deliver heat for longer periods of time when sufficient heat from the pumped liquid is not available, for example during days or weeks when the wind does not blow in a case where the source of rotational motion is a wind turbine, or when water flow rates are low in a case where the source of rotational motion is a water wheel/turbine.

The heating system may comprise a control module and a valve arrangement controlling flow of the pumped liquid through the one or more loops of piping, wherein the valve arrangement is configured to route the pumped liquid to pass through either the primary heat storage system or to pass through the secondary heat storage system, under control of the control module. Accordingly, the valve arrangement may be configured to route the pumped liquid to the primary heat storage system by default, but route the pumped liquid to the secondary heat storage system after the primary storage temperature of the primary heat storage system has reached a maximum level, for long-term storage of heat.

The primary heat storage system may comprise a container and the one or more loops of piping may comprise an input piping loop within the container, the input piping loop configured to receive the pumped liquid and conduct heat from the pumped liquid to a liquid within the container, the liquid within the container being at a primary storage temperature and storing thermal energy from the pumped liquid. The input piping loop may be immersed within the liquid within the container to heat the liquid. The heated liquid within the container may be used directly, for example as a supply of hot water, and/or the heat storage system may comprise an output piping loop immersed within the container and through which water to be heated is passed. The primary heat storage system preferably comprises a layer of insulation surrounding the container to reduce heat loss from the relatively high temperature liquid inside of the container.

The primary heat storage system may comprise a primary bypass valve connected in parallel with the primary input piping loop, and the primary heat storage system may be configured to open the bypass valve such that the pumped liquid will flow through the primary bypass valve instead of through the primary input piping loop when the temperature of the pumped liquid is beneath the primary storage temperature. Then, the pumped liquid will bypass the container in the event that the pumped liquid is cooler than the liquid inside the container, to prevent the pumped liquid from lowering the temperature of the liquid inside the container.

The primary heat storage system may comprise a temperature sensor configured to measure the primary storage temperature of the liquid inside the container, and a controller configured to compare the measured primary storage temperature to the temperature of the pumped liquid and control the primary bypass valve in dependence on the comparison. The heating system may comprise a temperature sensor upstream of the primary and secondary heat storage systems that is configured to measure the temperature of the pumped liquid, or the primary heat storage system may comprise a temperature sensor configured to measure the temperature of the pumped liquid that it receives.

The secondary heat storage system may comprise a reservoir and the one or more loops of piping may comprise an input piping loop within the reservoir, the input piping loop configured to receive the pumped liquid and conduct heat from the pumped liquid to the reservoir, the reservoir being at a secondary storage temperature and storing thermal energy from the pumped liquid. The reservoir may be an underground reservoir of water, for example a naturally occurring reservoir or a mine shaft or borehole that has been flooded with water. The reservoir could alternatively be a solid-state reservoir, for example an underground region of soil/clay/rock with the input piping loop extending throughout the underground region to provide heating of the soil/clay/rock. The reservoir does not typically require any thermal insulation, since the temperature gradients involved are relatively low given the large size and the relatively lower temperature of the secondary heat storage system.

The secondary heat storage system may comprise a secondary bypass valve connected in parallel with the secondary input piping loop, and the secondary heat storage system may be configured to open the secondary bypass valve such that the pumped liquid will flow through the secondary bypass valve instead of through the secondary input piping loop when the temperature of the pumped liquid is beneath the secondary storage temperature. Then, the pumped liquid will bypass the reservoir in the event that the pumped liquid is cooler than the reservoir, to prevent the pumped liquid from lowering the temperature of the reservoir.

The secondary heat storage system may comprise a temperature sensor configured to measure the secondary storage temperature of the reservoir, and a controller configured to compare the measured secondary storage temperature to the temperature of the pumped liquid and control the secondary bypass valve in dependence on the comparison. The heating system may comprise a temperature sensor upstream of the primary and secondary heat storage systems that is configured to measure the temperature of the pumped liquid, or the secondary heat storage system may comprise a temperature sensor configured to measure the temperature of the pumped liquid that it receives.

The heat pump may be configured to repeatedly circulate fluids through the secondary heat storage system and a cold storage system. The heat pump may comprise a compressor configured to raise a temperature of the fluid when flowing from the cold storage system, thereby enabling storage of unwanted heat in the secondary heat storage system for use at a later time. The fluids circulated through the secondary heat storage system and the cold storage system may be the same fluids as one another, or they may be different fluids with a heat exchanger positioned between them at the heat pump. The cold storage system may be connected to a cold supply loop for cooling a building, such as in summertime when temperatures can become uncomfortably hot. Accordingly, excess heat inside buildings may be transferred via the cold supply loop, cold storage system and the heat pump into the secondary heat storage system for use at a later date. The cold storage system may be maintained at a temperature of less than 10° C.

In accordance with a second aspect of the invention, the source of rotational motion may be a wind turbine comprising blades, wherein the blades are drag-style blades such that the rotational force produced by momentum transfer from the wind impacting against the blades is greater than the rotational force produced by the Bernoulli effect creating a pressure difference on opposing sides of the blade.

Drag-style blades rotate more slowly than aerofoil-style blades that rely on the Bernoulli effect and that are conventionally used for electric wind turbines. The slower speed of the drag-style blades results in a lower environmental impact, especially a lower noise level which is important for wind turbines adjacent residential areas. It is advantageous for the wind turbine to be close to residential areas but at least 100 m away from large buildings or trees to stop wind buffering causing component wear and to avoid excessive heat loss from the piping between the wind turbine and the residential areas.

A drag-style blade typically produces a higher torque than an aerofoil style blade moving at a similar speed would do. The higher torque enables the use of a drivetrain having high ratio gearing between the rotor having the blades and the shaft(s) of the at least one pump. For example, the gearing may have a ratio of between 40:1 and 200:1. The gearing preferably has a fixed rather than a variable ratio, to maximise the longevity of the gearing.

The width at the widest point along the blade may be at least 10% of the length of the blade, to give a large area of blade against which the wind can impact to produce rotational motion.

Each blade may have a substantially constant angle of attack along the length of the blade, in contrast to the aerofoil-style blades commonly fitted to wind turbines for electric generation. This is due to the way that drag-style blades work, primarily relying on momentum transfer from the wind to rotate them.

The angle of attack of each of the drag-style blades may be at least 12 degrees, for example 12 to 13 degrees, for most efficient conversion of wind motion to rotational motion. Aerofoil-style blades of wind turbines for electric generation commonly have angles of attack of around 7 degrees.

Each blade may comprise a leading edge formed of a first material and a main body formed of a second material, wherein the second material is a flexible fabric material and the first material is more rigid than the second material. The second material is supported by the first material and flexes to catch the wind. The leading edge may be curved in a direction along a length of the leading edge, and the main body of flexible fabric material may span over a region within the curved leading edge.

In accordance with a third aspect of the invention, the at least one pump may be a plurality of pumps, the source of rotatable motion may be configured to drive the plurality of pumps via a drivetrain, and the drivetrain may be configured to drive a variable number of the plurality of pumps to modulate a speed of rotation of the source of rotatable motion. Thus, the pumps can draw more or less energy from the source of rotational motion depending on the amount of torque that is available.

The drivetrain preferably drives the variable number of pumps all at the same speed as one another with the remaining ones of the plurality of pumps undriven. The variable number may be increased to drive more of the pumps when the speed of rotation of the source of rotatable motion rises above an upper threshold, thereby reducing the speed, and the variable number may be decreased to drive less of the pumps when the speed of rotation of the source of rotatable motion falls beneath a lower threshold, thereby increasing the speed. Accordingly the speed of the pump(s) may be maintained between the upper and lower thresholds provided there is at least enough torque available to drive one of the pumps above the lower threshold.

The drivetrain may comprise a controller configured to measure a speed of the source of rotational motion and vary the variable number of pumps being driven by the source of rotational motion in dependence on the speed. In the case where the source of rotatable motion is a wind turbine, the controller of the drivetrain may also adjust an angle of attack (pitch) of the turbine blades, and/or the direction in which the wind turbine faces (yaw), in order to help modulate the speed.

The heating system may comprise an electric generating and storage system comprising an electric generator which is driven by the source of rotational motion to generate electricity, for example at less than 50V, to power the controller(s) of the heating system. The electric generating and storage system may comprise a battery for storage of the generated electricity for times when the source of rotational motion does not provide sufficient rotational motion. When the source of rotational motion is a wind turbine, the generated electricity may be used to supply all the electrical needs of the wind turbine, for example to power motors controlling the direction (yaw) in which the wind turbine faces, and to power the various sensors and controllers of the wind turbine. The generated electricity may also be used for de-icing of the wind turbine in freezing temperatures to help keep the wind turbine operating optimally. Accordingly, the wind turbine may not require any mains electricity supply, and so may be cited remotely from electricity grid supplies.

In accordance with a fourth aspect of the invention, the at least one pump may comprise a centrifugal pump having a pumping efficiency of less than 20%, causing the frictional heating of the pumped liquid. Since less than 20% of the rotational energy input to the pump is converted to increased liquid flow/pressure at the output of the pump, most of the rotational energy input to the pump is dissipated as heat, which is carried by the liquid exiting the pump. The liquid repeatedly flows around the one or more loops of piping, increasing in temperature each time it passes through the pump, until it reaches a temperature that heat can begin to be stored in the primary or secondary heat stores.

The use of a centrifugal pump allows heat production without significant compression of the pumped liquid. In contrast to a positive displacement pump, a centrifugal pump has a very low starting torque and so can begin to turn even at low wind speeds and high drivetrain gear ratios. The centrifugal pump preferably has a pumping efficiency of less than 10%, more preferably less than 5%, and may even have a pumping efficiency of less than 3% in optimal designs. The pump may be cited within a distance of 100 m of the primary heat storage system, and, if implemented, the secondary heat storage system, so that the pumping power of the inefficient pump is sufficient to pump the liquid the distance to the primary and optional secondary heat storage systems.

The centrifugal pump may comprise an impeller, the impeller comprising a multitude of strands that extend radially outward from a central hub of the impeller. The multitude of strands may for example be a multitude of wires that together define a circular brush about the central hub of the impeller. The use of a multitude of radially extending strands/wires as the impeller results in a very inefficient pump, which transfers most of the input rotational energy to heat rather than to increased liquid flow/pressure. The impeller could alternatively comprise a plurality of radially extending vanes, wherein each of the plurality of vanes comprises apertures allowing flow of liquid through the vanes. This has a similar effect to the use of a multitude of strands, producing heating of the liquid through shear and frictional forces acting on the liquid.

The centrifugal pump may comprise a flow restrictor at the output of the centrifugal pump, the flow restrictor configured to restrict flow of the pumped liquid out of the centrifugal pump to reduce the pumping efficiency of the centrifugal pump. The flow restrictor produces heating of the liquid through shear and frictional forces acting on the liquid.

In accordance with a fifth aspect of the invention, the heating system may comprise a controller that is configured to control a flow valve to regulate a flow rate of the pumped liquid towards a desired flow rate value. The flow rate of the pumped liquid will depend on the speed of the pump, which depends on the speed of rotational motion. If the speed of the source of rotational motion increases, for example due to higher windspeed, then the flow rate of the pumped liquid goes up. The increase in speed of the source of rotational motion is undesirable once the speed reaches a certain level, and excessive speeds may result in reduced efficiency or premature wearing of components. To limit the speed of the source of rotational motion, once the flow rate rises above a desired flow rate value, the controller begins to close the flow valve. This makes it harder for the pump to pump the liquid around the circuit, reducing the speed of the source of rotational motion. The forcing of the pumped liquid through the partially closed flow valve results in shear and frictional forces at the flow valve which further heat the liquid, and further heating may also occur within the pump due to a higher output pressure required at the output of the pump.

If flow rate and pressure become more than needed for circulation and transfer of heat, additional heat may be made by partially closing the flow valve, at the expense of flow rate and pressure.

Therefore the flow valve provides another way of matching the energy supplied by the source of rotational motion to the heating of the pumped liquid, which may be in addition to connecting extra pumps to the source of rotational motion as was described further above. The flow valve may for example be a ball valve, since ball valves are effective at creating shear forces within the liquid when they are in a state of partial closure.

### DETAILED DESCRIPTION

Embodiments of the invention will now be described by way of non-limiting example only and with reference to the accompanying drawings, in which:

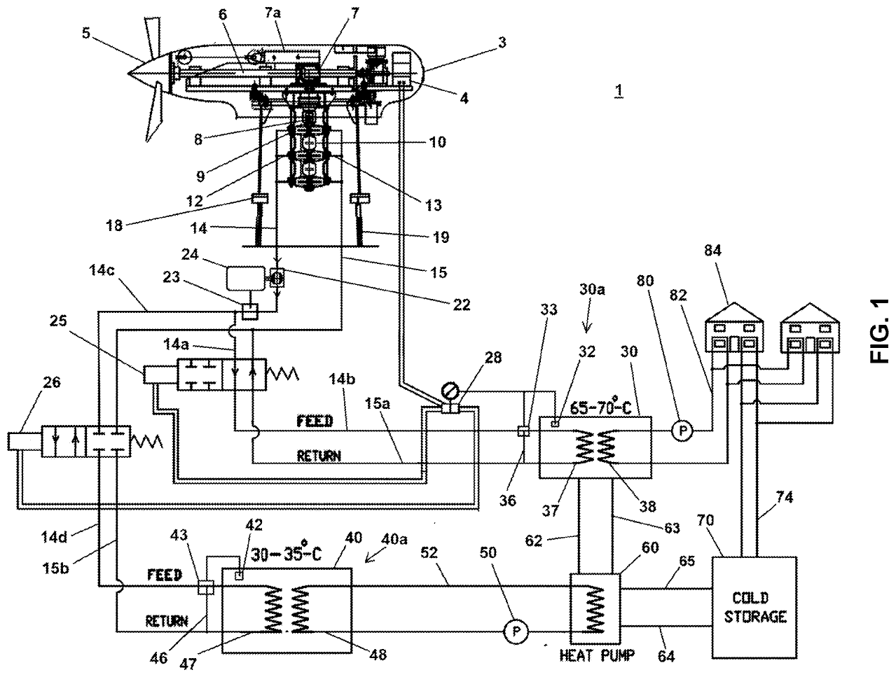

FIG. 1 shows a schematic diagram of a heating system according to an embodiment of the invention;

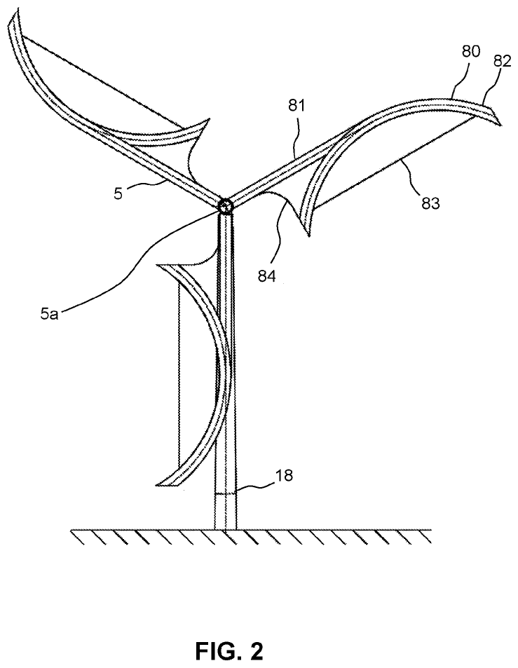

FIG. 2 shows a schematic diagram of a wind turbine forming part of the heating system of FIG. 1;

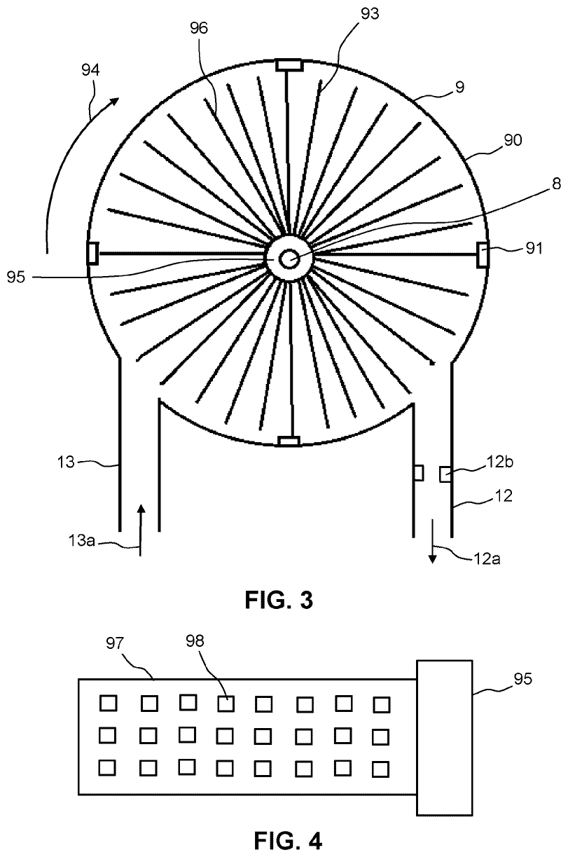

FIG. 3 shows a schematic diagram of a centrifugal pump forming part of the heating system of FIG. 1; and

FIG. 4 shows a schematic diagram of an alternative vane of a centrifugal pump that could be used in the centrifugal pump of FIG. 3.

The figures are not to scale, and same or similar reference signs denote same or similar features.

The schematic diagram of FIG. 1 shows a heating system 1, comprising a source of rotational motion in the form of a wind turbine 3, a primary heat storage system generally designated at 30a, a secondary heat storage system generally designated at 40a, a heat pump 60, and various piping connecting those elements.

The wind turbine 3 may comprise a base 18, a rotor 5 configured to rotate under the force of the wind, and a drivetrain comprising a rotor shaft 6, gearbox 7, pump shaft 8, and two clutches 10. The pump shaft 8 may drive three pumps 9 to rotate, the first pump connected directly to the pump shaft 8, the second pump connected to the pump shaft 8 via the first pump and the first clutch 10, and the third pump connected to the pump shaft 8 via the first pump, first clutch, second pump, and second clutch. The clutches 10 are actuable to select whether the pump shaft 8 drives only the first pump, only the first and second pumps, or all three of the pumps. The pump that are driven may all turn at the same speed as one another, typically corresponding to speed of the pump shaft 8. The pumps typically create less noise than an equivalent electric generator of similar input energy, and so are well suited to placement near residential areas.

The gearbox 7 may comprise a bevel gearbox at 1:1 ratio to convert the horizontal axis of rotation of the rotor shaft 6 to a vertical axis of rotation, and a planetary gearbox which may operate at ratios between 40:1 and 200:1 to drive the pump shaft 8 in a vertical axis of rotation. In alternate embodiments the bevel gearbox may have a ratio of up to 3:1.

The drivetrain may also comprise a controller 7a, which may measure the rotational speed of the rotor shaft 6, and control the clutches 10 based on the speed measurements. If the measured speed increases above an upper threshold then the controller controls the clutches to drive an additional pump, bringing the speed of the rotor shaft 6 back down due to the increased load of the extra pump. If the measured speed reduces below a lower threshold then the controller controls the clutches to drive one less pump, causing the speed of the rotor shaft 6 to increase due to the reduced load of the remaining pump(s). The speed of the rotor shaft 6 is therefore regulated to prevent it from becoming too high, and prevent the turbine blades from making too much noise. The controller 7a may for example regulate the speed of the pump shaft 8 to be between 600 and 3000 rpm.

In this embodiment, each pump 9 may be nominally rated at 33 KW to produce a total 100 KW of heat when all three pumps are connected to the pump shaft 8 via the clutches 10 and the wind is blowing at a nominal 12 metres per second. At higher winds speeds the pumps may produce even higher output provided the drivetrain is rated to cope with the higher energy transferred.

The use of three separate pumps at 33 KW that are connected/disconnected to the wind turbine allows the load of the pumps to be matched to the available wind more effectively than a single pump at 100 KW could be matched to the available wind. Alternative embodiments may implement two, four or five pumps, or even more pumps.

Each of the three pumps 9 may have an outlet 12 and an inlet 13, all three outlets 12 connected to a main feed pipe 14 and all three inlets 13 connected to a main return pipe 15. The main feed pipe 14 may be connected to an inlet of a flow valve, for example in this embodiment an inlet of a ball valve 22. The ball valve 22 is a known type of valve in which a ball with a hole therethrough can be rotated within a seating, to control the rate of fluid flowing through the valve. The rate of fluid flowing through the ball valve 22 may be measured by a flow meter 23 at the outlet of the ball valve. The ball valve 22 may be controlled by a controller 24, which is connected to the flow meter 23. The controller 24 may be configured to increase the amount of opening of the ball valve 22 in response to the flow meter 23 measuring a lower than desired flow rate, and to decrease the amount of opening of the ball valve 22 in response to the flow meter 23 measuring a higher than desired flow rate. According, the flow rate from the main feed line 14 can be regulated towards the desired flow rate. The desired flow rate may be programmed into the controller 24.

The outlet of the flow valve may be connected to both a second feed pipe 14a and a fourth feed pipe 14c. The second feed pipe 14a may connect to a primary solenoid valve 25, and the fourth feed pipe 14c may connect to a secondary solenoid valve 26. The main return pipe 15 may also connect to both the primary and secondary solenoid valves 25 and 26.

The primary solenoid valve 25 may control a connection of the second feed pipe 14a to a third feed pipe 14b, and may also control a connection of the main return pipe 15 to a second return pipe 15a. When the primary solenoid valve 25 is open, the second feed pipe 14a is connected to the third feed pipe 14b, and the main return pipe 15 is connected to the second return pipe 15a. When the primary solenoid valve 25 is closed, the second feed pipe 14a is disconnected from the third feed pipe 14b, and the main return pipe 15 is disconnected from the second return pipe 15a.

The secondary solenoid valve 26 may control a connection of the fourth feed pipe 14c to a fifth feed pipe 14d, and may also control a connection of the main return pipe 15 to a third return pipe 15b. When the secondary solenoid valve 26 is open, the fourth feed pipe 14c is connected to the fifth feed pipe 14d, and the main return pipe 15 is connected to the third return pipe 15b. When the solenoid valve 26 is closed, the fourth feed pipe 14c is disconnected from the fifth feed pipe 14d, and the main return pipe 15 is disconnected from the third return pipe 15b.

The solenoid valves 25 and 26 may be actuated in opposition from one another by a control module 28, so that when one solenoid valve is open the other solenoid valve is closed. FIG. 1 shows the solenoid valve 25 in the open state and the solenoid valve 26 in the closed state. In that state, the pumps 9 may circulate liquid around a loop comprising the pipes 14, 14a, 14b, 15a and 15. The loop may also comprise a primary input piping loop 37, which may be connected between the third feed pipe 14b and the second return pipe 15a, and which may pass through the primary heat storage system 30a.

More specifically, the primary heat storage system 30a may comprise a container 30, filled with a liquid heat storage medium such as water. The primary input piping loop 37 may be immersed in the water within the container, heating the water in the container 30 as the liquid from the pumps passes through the primary input piping loop 37. The primary heat storage system 30a may also comprise a temperature sensor 32 configured to monitor the temperature of the water in the container 30, and a primary bypass valve 33 that may divert the pumped liquid from the third feed line 14b to a primary bypass pipe 36, instead of to the primary input piping loop 37. The primary bypass pipe 36 may connect from the third feed pipe 14b to the second return pipe 15a, bypassing the container 30 and the primary input piping loop 37.

The primary bypass valve 33 is connected to the temperature sensor 32, and also has its own temperature sensor that senses the temperature of the pumped liquid flowing through the third feed pipe 14b. If the temperature of the pumped liquid is higher than the temperature of the liquid inside the container 30, then the bypass valve 33 connects the third feed line 14b to the primary input piping loop 37 to heat the water in the container. If the temperature of the pumped liquid is lower than the temperature of the liquid inside the container 30, then the bypass valve 33 connects the third feed line 14b to the primary bypass pipe 36 to bypass the container and prevent the pumped liquid from drawing heat out of the primary heat storage system.

The temperature sensor 32 may also be connected to the control module 28, which controls the states of the primary and secondary solenoid valves 25 and 26. The control module 28 may be configured to open the primary solenoid valve 25 and close the secondary solenoid valve 26 when the temperature sensor 32 reports the temperature of the liquid inside the container 30 is less than a threshold temperature, in this example a temperature of 70° C. Then, the pumped liquid from the main feed line 14 may pass through the primary input piping loop 37 within the container 30, provided the pumped liquid is hotter than the liquid inside the container 30, warming the liquid in the container 30 and storing heat.

The control module 28 may be configured to close the primary solenoid valve 25 and open the secondary solenoid valve 26 when the temperature sensor 32 reports the temperature of the liquid inside the container 30 is greater than the threshold temperature, in this example the temperature of 70° C. Then, the pumps 9 may circulate liquid around a loop comprising the pipes 14, 14c, 14d, 15b and 15. The loop may also comprise a secondary input piping loop 47, which may be connected between the fifth feed pipe 14d and the third return pipe 15b, and which may pass through the secondary heat storage system 40a.

More specifically, the secondary heat storage system 40a may comprise a reservoir 40, for example a water reservoir or a mine shaft or borehole filled with water. The secondary input piping loop 47 may be immersed in the water within the reservoir, heating the water in the reservoir 40 as the liquid from the pumps 9 passes through the secondary input piping loop 47. The secondary heat storage system 40a may also comprise a temperature sensor 42 configured to monitor the temperature of the reservoir 40, and a secondary bypass valve 43 that may divert the pumped liquid from the fifth feed line 14d to a secondary bypass pipe 46, instead of to the secondary input piping loop 47. The secondary bypass pipe 46 may connect from the fifth feed pipe 14d to the third return pipe 15b, bypassing the reservoir 40 and the secondary input piping loop 47.

The secondary bypass valve 43 may be connected to the temperature sensor 42, and also has its own temperature sensor that senses the temperature of the pumped liquid flowing through the fifth feed pipe 14d. If the temperature of the pumped liquid is higher than the temperature of the reservoir 40, then the secondary bypass valve 43 connects the fifth feed line 14d to the secondary input piping loop 47 to heat the reservoir. If the temperature of the pumped liquid is lower than the temperature of the reservoir 40, then the secondary bypass valve 43 connects the fifth feed line 14d to the secondary bypass pipe 46 to bypass the reservoir and prevent the pumped liquid from drawing heat out of the secondary heat storage system.

The control module 28 and optionally any other controllers may be powered by an electric generating and storage system 4. The electric generating and storage system 4 comprises an electric generator which is driven by the rotor shaft 6 of the wind turbine to produce electricity, and a battery for storing the electricity. The voltage of the battery may for example be 24V. The generated electricity may be used to actuate the solenoids 25 and 26, and the clutches 10.

The container 30 of the primary heat storage system may be sized to hold enough liquid to store enough heat to meet 24 hrs of heat demand from one or more houses 84. That is, the temperature of the liquid inside the container may fall from an upper temperature threshold, for example 70° C., to a lower temperature threshold, for example 65° C., during a full day of heat usage from the houses 84 without any heat being added to the liquid inside the container 30 by the primary input piping loop 37. The allowed temperature range of 65° C. to 70° C. is sufficiently high to meet all the thermal needs of the houses 84. In order to provide this heat to the houses 84, the system may comprise a heat supply loop 82, including a pump 80, which pumps liquid such as water to circulate around the heat supply loop. The heat supply loop may comprise a primary output piping loop 38 passing through the container 30 and immersed in the liquid in the container 30, for absorbing heat from the liquid in the container 30. The heat supply loop 82 may include radiators inside the houses 84 for heating the houses, and/or heat exchangers for heating water.

The reservoir 40 may hold a much larger volume of liquid than the container 30 of the primary heat exchanger, for example ten times as much liquid, and may also store heat in the earth/soil/rock surrounding the reservoir as well as in the liquid since no specific insulation is required at the relatively low temperatures contemplated. The temperature of the reservoir may for example be heated up to between 30° C. and 35° C. The reservoir 40 stores a large volume of heat which can be called upon to replenish the primary heat storage system 30a when there is insufficient heat from the primary input piping loop 37 to keep the liquid in the container 30 up to the required temperature, for example 65° C.

To transfer heat from the secondary heat storage system 40a to the primary heat storage system 30a, the system may comprise the heat pump 60. The heat pump 60 comprises a heat supply loop 52, including a secondary output piping loop 48 passing through the reservoir 40, for absorbing heat from the reservoir 40. The heat pump comprises a pump 50 which circulates liquid around the heat supply loop 52, drawing heat from the secondary heat storage system 40a. The heat pump 60 may be a conventional heat pump, and so the internal details of the heat pump are not discussed in detail herein. The heat pump 60 typically comprises a piping loop including an evaporator and a compressor, around which a refrigerant is pumped. In this example, hot refrigerant is pumped to the primary heat storage system along pipe 62, and then once the heat from the refrigerant has been stored by the liquid in the container 30, the refrigerant returns along pipe 63 to the evaporator. The evaporator reduces the temperature of the refrigerant, and then the refrigerant is heated using heat from the heat supply loop 52, and then compressed with the compressor to raise its temperature, before being sent along the pipe 62 again. It will be understood that the refrigerant could alternatively be sent directly to the secondary heat storage system 40a instead of using the intermediate heat supply loop 52 to transfer heat from the secondary heat storage system 40a to the refrigerant.

The heat pump 60 may be controlled by the control module 28, and the control module 28 may activate the heat pump when the temperature sensor 32 indicates the temperature of the liquid in the container 30 has dropped below the lower temperature threshold, for example of 65° C. This transfers heat from the secondary heat storage system 40a into the primary heat storage system 30a, raising the temperature of the liquid in the container 30.

The heat pump may be sized to have a capacity that is sufficient to supply enough heat to the primary heat storage system when no heat is generated by the pumps driven by the source of rotational motion. For example, in a system where the temperature of the secondary heat storage system is at least 30° C., and the temperature is to be raised by 40° C. by the heat pump, meaning the heat pump may have a Coefficient of Performance (COP) of at least 8, the heat pump may be rated as one eighth of the anticipated heat demand from the primary heat storage system. If the source of rotational motion nominally provides 100 KW in average wind conditions, then the heat pump may be rated at an electrical input of 12.5 KW to provide the 100 KW to the primary heat storage system when there is no wind. Accordingly, if the source of rotational motion is nominally rated at X KW, and the heat pump has a coefficient of performance of Y when the primary and secondary heat storage systems are at their intended temperatures, then the heat pump may be rated with an electrical input of at approximately X/Y.

The heat pump is just one example of how to achieve security of supply for times when the source of rotational motion does not provide sufficient energy. In alternate embodiments, the heating system may comprise one or more additional sources of heat, for example a thermal solar heating array connected to the one or more loops of piping and that heats the liquid passing through the one or more loops of piping. The heating system could also comprise a gas burner to heat the liquid in the container 30 of the primary heat storage system, for use in emergencies, for example when insufficient heat was supplied to the primary heat storage system from the one or more loops of piping and/or the heat pump. An electric immersion heater could also be implemented in the container 30 to provide heat in emergencies, instead of or in addition to implementing the gas burner. Microwave or induction heating systems could also/alternatively be used.

In this embodiment, the one or more loops of piping include the loop comprising the pipes 14, 14a, 14b, 15a and 15s, and the loop comprising the pipes 14, 14c, 14d, 15b and 15, one of which is selected by the solenoid valves 25 and 25 to circulate the pumped liquid. However, in alternate embodiments it may be possible to use a single loop of piping that first routes the pumped liquid to the primary heat storage system and then subsequently routes the pumped liquid to the secondary heat storage system.

In summertime, there may be an excess of heat inside of the houses 84, which could usefully be stored in the secondary heat storage system 40a for use months into the future. Therefore, the system may comprise a cold supply loop 74 around which liquid such as water is pumped to absorb heat. The cold supply loop 74 transfers heat to the cold storage system 70, which may be a similar to the reservoir 40 but at a lower temperature. The cold storage system may for example be maintained at a temperature of less than 10° C. by the heat pump to provide effective cooling of the houses in summertime.

To transfer heat from the cold storage system 70 to the secondary heat storage system 40a, the heat pump 60 may pump refrigerant to the cold storage system 70 along a pipe 64, which returns at a higher temperature along pipe 65, to the compressor of the heat pump. The compressor raises the temperature of the refrigerant, and the heat is transferred to the heat supply loop 52, storing the heat in the secondary heat storage system 40a. The refrigerant then passes through the evaporator, before being sent along pipe 64 again to the cold storage. Clearly the evaporator could alternatively be situated within the cold storage system 70 if desired. The primary heat storage system 30a and the cold storage system 70 may be used in tandem to keep temperatures within the houses 84 at the desired level, performing climate control.

The wind turbine 3 will now be described in more detail with reference to FIG. 2, which shows a schematic diagram of the wind turbine 3. As shown, the wind turbine 3 comprises the base 18, and the rotor 5. The rotor 5 may have three curved blades 80 supported by three respective supports 81, the supports 81 extending radially from a central axis 5a of the rotor and at 120 degrees apart from one another. Each blade 80 may have a leading edge 82 which is formed of a strip of rigid material such as aluminium. The leading edge 82 may be curved along its length, thereby defining a scimitar shape that helps reduce noise, and a main body of flexible fabric material 83 such as a sail may span over a region within the curved leading edge, as shown. The sail may for example be formed of a woven cloth, or a plastics material.

The curvature of the leading edge 82 and the connection of the blade 80 to the support 81 defines the angle of attack of the blade 80. The angle of attack is the angle between a width-wise direction across the blade and the direction of movement of the blade as it rotates about the axis 5a. In this example the angle of attack is 12.5 degrees, and it corresponds to the angle between the plane in which the supports 81 rotate and the plane in which the flexible fabric material 83 extends.

Optionally, the leading edges 82 may be connected to the supports 81 in a manner that allows each leading edge 82 to be rotated about a pivot axis that is aligned with the corresponding support 81, allowing adjustment of the angle of attack, for example to modulate or reduce the speed of the blades in very windy conditions.

The flexible fabric material 83 and curved shape of the leading edge 82 provides a large blade area which is impacted by the wind to drive rotation of the blades 80. The flexible fabric material 83 may be two-dimensional, or in other words extend in length and width dimensions but have very little thickness. The flexible fabric material 83 may be tightly stretched across the region defined by the leading edge 82, thereby defining drag-style blades which are primarily forced to turn by the wind impacting against the blades, rather than pressure differences on either side of the flexible fabric material 83 created by the Bernoulli effect.

The leading edge 82 may have a thickness defining an aerofoil across a width of the leading edge to smoothly guide air over the leading edge and onto the flexible fabric 83 as the blade rotates. Each blade 80 may have a second body of flexible fabric material 84, spanning a region between the support 81 and the leading edge 82. The second body of flexible fabric material 84 increases the area of the blade 80 that is impacted by the wind, and so improves performance.

The pumps 9 of the wind turbine 3 will now be described in more detail with reference to FIG. 3, which shows a schematic diagram of one of the pumps 9. The pump 9 is shown looking along the axis of the pump shaft 8, and the pump 9 may comprise a pump housing 90 and an impeller 93.

The impeller 93 may comprise a central hub 95 and a multitude of stands 96 extending radially from the central hub 95, as shown. There may be hundreds, or even thousands, of the strands 96 extending from the central hub 95. The strands may be wire strands, preferably twisted wire strands so that each strand has an uneven surface and creates turbulence. The strands may be formed of steel, or could alternatively be formed form other types of materials such as plastics. The central hub 95 may be fixed to the pump shaft 8, and so rotate when the source of rotational motion rotates the pump shaft 8. The impellor 93 may therefore be in the form of a circular brush, which rotates inside the pump housing 90, in the direction shown by arrow 94.

The pump housing defines the inlet 13 and the outlet 12, the inlet 13 receiving liquid returning from the loop(s) of piping in direction 13a, and the pump 90 pumping liquid from the outlet 12 in direction 12a to feed the loop(s) of piping.

The pump housing 90 may comprise baffles 91 on internal surfaces facing radially towards the impeller 93. The baffles are configured to disrupt the flow of liquid from the inlet 13 to the outlet 12 along the internal surfaces of the pump housing. The baffles may be strips that are aligned parallel to the axis of the pump shaft 8, and may have angular edges, to maximise the turbulence that they induce in the flow of liquid through the pump. The outlet 12 may also have a flow restrictor 12b to further reduce the pumping efficiency of the pump and increase the amount of heat imparted to the pumped liquid.

When the impellor 93 is rotated by the pump shaft 8, the strands 96 pump fluid from the inlet 13 to the outlet 12, but generate a lot of shear and turbulence in the pumped liquid as they do so, creating heat through friction. The baffles 91 also disrupt the flow of the pumped liquid through the pump, again creating heat through friction. Less than 20% of the rotational energy supplied to the pump shaft 8 is imparted to the liquid in the form of increased flow/pressure, and most of the rotational energy results in heating of the liquid. Since the liquid continuously flows around the loop(s) of piping, the liquid progressively increases in temperature. The pumped liquid may for example be water, or oil. Heat may be produced up to 90° C. using a water/ethylene glycol mix for the pumped liquid, or to 100° C. or more using oil for the pumped liquid.

The pump 9 therefore sacrifices flow rate and pressure for heat by generating high Reynolds numbers between the impeller 93 and the uneven inner surface of the pump housing 90. Rotational energy imparted to the liquid is focused towards the outside edge of the impellor 93 where the greatest surface area is and greatest area of liquid friction. Since the multitude of strands extend radially from the central hub 95, they are spaced more closely to one another nearer the central hub 95 than near the outer ends of the strands, and this helps encourage the liquid towards the outer ends of the strands where the speed is higher and the heat produced by friction is greater.

The pump housing 90 may be substantially circular, for example in the shape of a disc, with a central axis corresponding to the axis of the pump shaft 8. The pumps 9 are therefore easily stacked upon one another and housed within the circular base 18 of the wind turbine, with the rotational axes of the pump impellers all aligned along a same axis, corresponding to the axis of the pump shaft 8.

FIG. 4 shows a vane 97 of an alternative impellor, the vane for extending radially from the central hub 95 instead of or in addition to the multitude of strands 96. The vane has a plurality of holes 98 through which liquid is forced during pumping, producing shear forces that reduce the pumping efficiency and generate heat through friction. A large number of the vanes 97 may extend radially from the central hub 95, and the vanes may have the holes 98 at differing positions on the vanes to one another.

Many other variations of the described embodiments falling within the scope of the invention will be apparent to those skilled in the art.

What is claimed is:

1. A heating system, comprising a source of rotational motion, at least one pump, primary and secondary heat storage systems, one or more loops of piping connected to the primary and secondary heat storage systems, and a heat pump connected between the primary and secondary heat storage systems, wherein the source of rotational motion is configured to drive the at least one pump, wherein the at least one pump is configured to pump liquid to repeatedly circulate around the one or more loops of piping, resulting in frictional heating of the pumped liquid and transfer of heat to the primary and secondary heat storage systems, wherein the primary heat storage system is configured to store a smaller amount of thermal energy at a higher temperature than the secondary heat storage system is configured to store, and wherein the heat pump is configured to transfer thermal energy from the secondary heat storage system to the primary heat storage system.

2. The heating system of claim 1, comprising a control module and a valve arrangement controlling flow of the pumped liquid through the one or more loops of piping, wherein the valve arrangement is configured to route the pumped liquid to either pass through the primary heat storage system or to pass through the secondary heat storage system, under control of the control module.

3. The heating system of claim 2, wherein the control module is configured to receive a temperature measurement from the primary heat storage system and control the valve arrangement to route the pumped liquid to the primary heat storage system unless the temperature measurement indicates the primary heat storage system has reached a maximum temperature.

4. The heating system of claim 1, wherein the primary heat storage system comprises a container and the one or more loops of piping comprise a primary input piping loop within the container, the primary input piping loop configured to receive the pumped liquid and conduct heat from the pumped liquid to a liquid within the container, the liquid within the container being at a primary storage temperature and storing thermal energy from the pumped liquid.

5. The heating system of claim 4, wherein the primary heat storage system comprises a primary bypass valve connected in parallel with the primary input piping loop, and wherein the primary heat storage system is configured to open the bypass valve such that the pumped liquid will flow through the primary bypass valve instead of through the primary input piping loop when the temperature of the pumped liquid is beneath the primary storage temperature.

6. The heating system of claim 1, wherein the secondary heat storage system comprises a reservoir and the one or more loops of piping comprise a secondary input piping loop within the reservoir, the secondary input piping loop configured to receive the pumped liquid and conduct heat from the pumped liquid to the reservoir, the reservoir being at a secondary storage temperature and storing thermal energy from the pumped liquid.

7. The heating system of claim 6, wherein the secondary heat storage system comprises a secondary bypass valve connected in parallel with the secondary input piping loop, and wherein the secondary heat storage system is configured to open the secondary bypass valve such that the pumped liquid will flow through the secondary bypass valve instead of through the secondary input piping loop when the temperature of the pumped liquid is beneath the secondary storage temperature.

8. The heating system of claim 1, wherein the heat pump is configured to repeatedly circulate fluids through the primary and secondary heat storage systems, and comprises a compressor configured to raise a temperature of the fluids when flowing from the secondary heat storage system.

9. The heating system of claim 1, wherein the heat pump is configured to repeatedly circulate fluids through the secondary heat storage system and a cold storage system, and comprises a compressor configured to raise a temperature of the fluids when flowing from the cold storage system.

10. The heating system of claim 1, wherein the source of rotational motion is a wind turbine.

11. (canceled)

12. (canceled)

13. (canceled)

14. (canceled)

15. (canceled)

16. A heating system, comprising a source of rotational motion, at least one pump, a primary heat storage system, and one or more loops of piping connected to the primary heat storage system, wherein the source of rotational motion is configured to drive the at least one pump, wherein the at least one pump is configured to pump liquid to repeatedly circulate around the one or more loops of piping, resulting in frictional heating of the pumped liquid and transfer of heat to the primary heat storage system, wherein the at least one pump is a plurality of pumps, wherein the source of rotatable motion is configured to drive the plurality of pumps via a drivetrain, and wherein the drivetrain is configured to drive a variable number of the plurality of pumps to modulate a speed of rotation of the source of rotatable motion.

17. The heating system of claim 16, wherein the drivetrain comprises a plurality of clutches which are actuable to vary the number of the plurality of pumps that are driven by the source of rotational motion.

18. A heating system, comprising a source of rotational motion, at least one pump, a primary heat storage system, and one or more loops of piping connected to the primary heat storage system, wherein the source of rotational motion is configured to drive the at least one pump, wherein the at least one pump is configured to pump liquid to repeatedly circulate around the one or more loops of piping, resulting in frictional heating of the pumped liquid and transfer of heat to the primary heat storage system, wherein the at least one pump comprises a centrifugal pump having a pumping efficiency of less than 20%, causing the frictional heating of the pumped liquid.

19. The heating system of claim 18, wherein the centrifugal pump comprises an impeller, the impeller comprising a multitude of strands that extend radially outward from a central hub of the impeller.

20. The heating system of claim 19, wherein the multitude of strands are a multitude of wires that together define a circular brush about the central hub of the impeller.

21. The heating system of claim 18, wherein the centrifugal pump comprises an impeller, the impeller comprising a plurality of vanes that extend radially outward from a central hub of the impeller, and wherein each of the plurality of vanes comprises apertures allowing flow of liquid through the vanes.

22. The heating system of claim 19 wherein the centrifugal pump comprises a pump housing that houses the impeller, and wherein an inside surface of the pump housing facing radially towards the impellor comprises one or more baffles configured to disrupt the flow of the pumped liquid along the inside surface.

23. The heating system of claim 18, wherein the centrifugal pump comprises a flow restrictor at an output of the centrifugal pump, the flow restrictor configured to restrict flow of the pumped liquid out of the centrifugal pump to reduce the pumping efficiency of the centrifugal pump.

24. The heating system of claim 1, comprising a controller and a flow valve, wherein the source of rotational motion is configured to drive the at least one pump, wherein the at least one pump is configured to pump liquid to repeatedly circulate around the one or more loops of piping, resulting in frictional heating of the pumped liquid, and wherein the controller is configured to control the flow valve to regulate a flow rate of the pumped liquid towards a desired flow rate value.

25. The heating system of claim 1, further comprising an electric generating and storage system including an electric generator which is driven by the source of rotational motion to generate electricity, and a battery for storage of the generated electricity.
